(19) United States
(12) Patent Application Publication
(10) Pub. No.: US 2021/0328962 A1
(43) Pub. Date: Oct. 21, 2021

(54) COMPUTER SOFTWARE SYSTEM AND METHOD FOR CREATING AND SCHEDULING POSTS ON MULTIPLE SOCIAL MEDIA PLATFORMS SIMULTANEOUSLY

(71) Applicant: Claude Hanna Bou-Abboud, Bel Air, MD (US)

(72) Inventor: Claude Hanna Bou-Abboud, Bel Air, MD (US)

(21) Appl. No.: 17/301,878

(22) Filed: Apr. 16, 2021

Related U.S. Application Data
(60) Provisional application No. 63/011,079, filed on Apr. 16, 2020.

(51) Int. Cl. H04L 12/58; G06Q 50/00; G06Q 10/10

(52) U.S. Cl. CPC H04L 51/32; G06Q 10/1095; G06Q 50/01

(57) ABSTRACT

The present invention comprises a system, method and software application for social media subscribers to post simultaneously on multiple platforms, or post multiple times throughout a certain time period. The system, method and software allow users to create message posts in a single step for posting on multiple platforms, and schedule posts to occur automatically as scheduled. The system comprises a computing device, and a software program downloadable to or accessible by the computing device. The computer-implemented method may include creating a user database, creating a social media post, selecting at least one social media platform destination, scheduling posting of the post, storing post data, analyzing data and generating a data analysis report accessible by the user. The present invention enables the user to create and schedule posts on multiple social media platforms, and permits minimization of processing time, enabling the user to save time and money for future planning.

### CROSS-REFERENCE TO RELATED APPLICATION

This application claims the benefit of priority of U.S. Provisional Application No. 63/011,079, filed Apr. 16, 2020, the contents of which are herein incorporated by reference.

### BACKGROUND OF THE INVENTION

The present invention relates to computer systems and methods and more particularly, computer system and method to create and schedule posts on multiple social media platforms simultaneously.

Post (v) is defined, to publish (something, such as a message) in an online forum (such as an electronic message board). Post (n) is defined as something that is published online.

Posting on current social networking systems require a user to separately post a single post if the user wishes to post a single post on multiple social networks. Therefore multiple steps are required when posting the same post on multiple social media platforms.

Too much time is taken switching from one social media platform to another. No current systems allow users to simultaneously send and schedule posts to multiple social media platforms. Current systems cannot create and schedule on multiple platforms at the same time.

A need exists for a solution which allows a single post from one source to be scheduled and simultaneously sent to multiple social media platforms. There is a need to minimize the processing time of creating and scheduling social media posts, in order to may save time and money for future planning.

### SUMMARY OF THE INVENTION

Advantageously, in one aspect, the present invention provides a computer system and method to create and schedule posts on multiple social media platforms simultaneously.

In one aspect, the present invention may comprise a system and method which solves the problem social media subscribers face in having to post the same social media posts on multiple platforms, or even the same post multiple times throughout a certain period. The system and method of the present invention allows users to use a system application to create posts in a single step instead of creating the same post multiple times for different platforms, and to further schedule the post based on when they want it to post automatically.

In a further aspect, the present invention comprises a system, method and software application for social media subscribers to post simultaneously on multiple platforms, or post multiple times throughout a certain time period. The system, method and software allow users to create message posts in a single step for posting on multiple platforms, and schedule posts to occur automatically as scheduled. The system comprises a computing device, and a software program downloadable to or accessible by the computing device. The computer-implemented method may include creating a user database, creating a social media post, selecting at least one social media platform destination, scheduling posting of the post, storing post data, analyzing data and generating a data analysis report accessible by the user. The present invention enables the user to create and schedule posts on multiple social media platforms, and permits minimization of processing time, enabling the user to save time and money for future planning.

In a still further aspect, the present invention provides a system application comprising a simplified scheduling page that allows users to easily schedule posts based on date and time. The simplified scheduling page comprises a graphical user interface further comprising a plurality of fields. The fields include a text message field, event fields, uploading fields and destination fields. The event fields may include date, start time and end time fields. The uploading fields may be for uploading images; video or sound files, documents or the like. The destination fields may comprise destination buttons for selecting at least one social media destination. The social media destination may be any social media platform, for example without limitation, Instagram, Facebook, Twitter, Etsy, LinkedIn, YouTube, Facebook, Instagram, TikTok, Pinterest, Reddit, Snapchat, or combinations thereof. The scheduling page may also include an “Apply” button for completing the scheduling process after the fields have been selected and completed.

The present invention enables the user to avoid multiple steps in posting the same post on multiple social media platforms. The present invention distinguishes over and differs from what currently exists. Other systems cannot create and schedule posts on multiple platforms at the same time.

The present invention allows users to create a post on the application and schedule to multiple social media destinations simultaneously. The present invention provides an unprecedented improvement over existing solutions. Other platforms do not allow you to send post(s) from one source. The present invention allows the user to create current or future posts on the inventive application and then schedule them. The present invention prevents having to switch from one platform to another and saves time. The present invention minimizes processing time of creating and scheduling social media posts, providing a way to save time and money for future planning.

The present invention allows the user to retrieve statistics on all historical and planned posts, providing valuable marketing data, which may be beneficially used for future planning. It also produces analyzed data on the social media posts for users to make marketing related decisions.

The present invention may be applicable to a wide variety of industries. The present invention may produce from the data that is generated through use of the application. The data produced by this application may be used to develop marketing techniques.

These and other features, aspects and advantages of the present invention will become better understood with reference to the following drawings, description and claims.

### BRIEF DESCRIPTION OF THE DRAWINGS

The preferred embodiment of the claimed subject matter will hereinafter be described in conjunction with the appended drawings provided to illustrate and not to limit the scope of the claimed subject matter, where like designations denote like elements, and in which:

FIG. 1 is a system diagram of an exemplary embodiment of the present invention;

FIG. 2 is a flow chart of an exemplary embodiment of the present invention.

FIG. 3 is screen shot of a post creation page in accordance with an exemplary embodiment of the present invention; and

FIG. 4 is a screen shot of an analytics page of an exemplary embodiment of the present invention.

It is to be understood that like reference numerals refer to like parts throughout the several views of the drawings.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

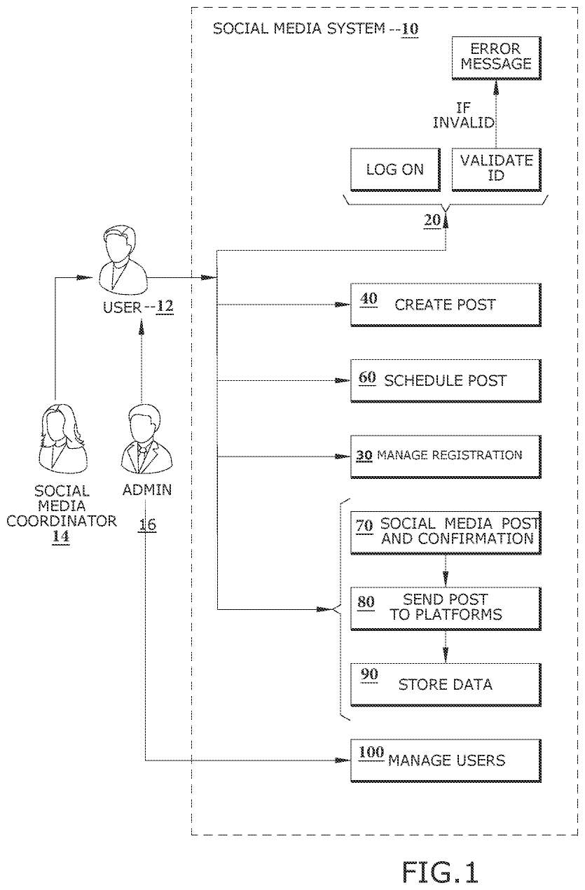

As used herein, “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, as there is no intention to be bound by any express or implied theory presented in the preceding technical field, background, brief summary or the following detailed description, it is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Broadly, one embodiment of the present invention provides a computer system and method to create and schedule posts on multiple social media platforms simultaneously.

The system of the present invention may include at least one computer with a user interface. The computer may include at least one processing unit coupled to a form of memory. The computer may include, but may not be limited to, a microprocessor, a server, a desktop, laptop, and smart device, such as, a tablet and smart phone. The computer may include a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The ordered combination of various ad hoc and automated tasks in the presently disclosed platform necessarily achieve technological improvements through the specific processes described more in detail below. In addition, the unconventional and unique aspects of these specific automation processes represent a sharp contrast to merely providing a well-known or routine environment for performing a manual or mental task.

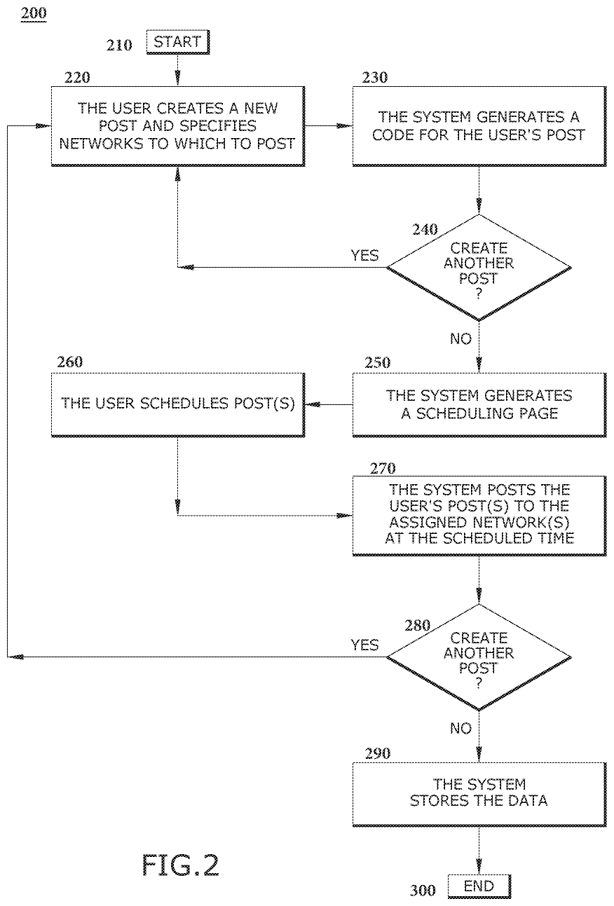

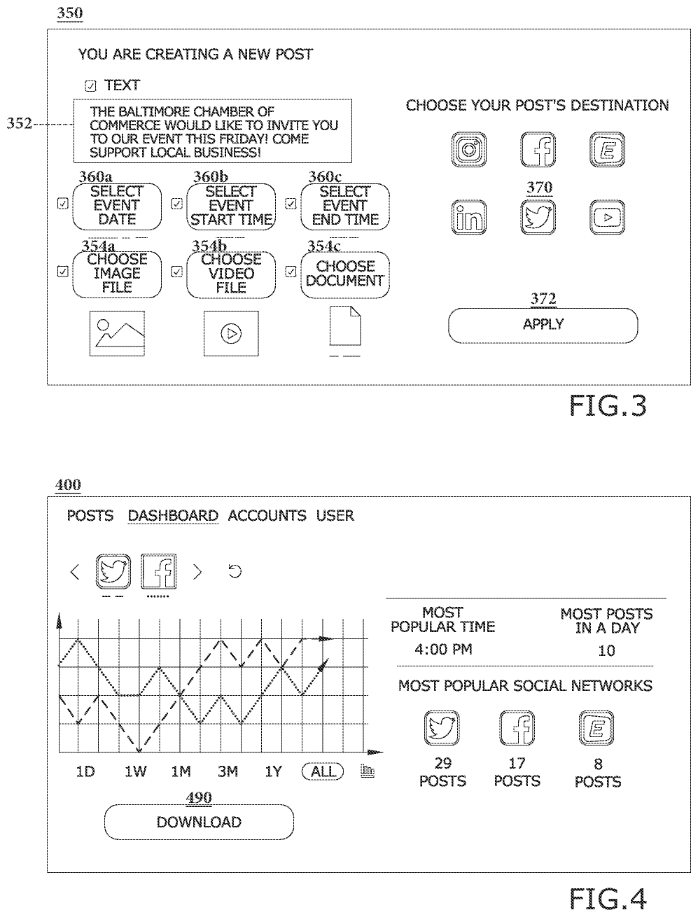

FIG. 1 shows a system diagram of an exemplary embodiment of the present invention. FIG. 2 shows a flow chart of an exemplary embodiment of the present invention. FIG. 3 is screen shot of a post creation page in accordance with an exemplary embodiment of the present invention. FIG. 4 is a screen shot of the system dashboard showing an analytics page of an exemplary embodiment of the present invention.

Referring to the Figures, the system of the present invention may include one or more of the following elements, components or features and combinations thereof.

In an exemplary embodiment shown at FIG. 1, a social media system 10 is provided for a user 12 to manage registration 30, create and schedule posts 40, 60 on multiple social media platforms simultaneously.

The system 10 system may comprise a computing device operable by a user 12 and a software program downloadable to the computing device or accessible by the computing device, the software program comprising: a user dashboard (FIG. 4) accessible by the user on the computing device; and a user database 90 created by the software program for storage of the user data, user social media posts and user social media post data.

The system 10 is comprised of a computing device operable by a user 12 and a software program downloadable to the computing device or accessible by the computing device. The software application program may comprise a user dashboard (FIG. 4) accessible by the user on the computing device and a user database 90 created by the software program for storage of the user data, user social media posts and user social media post data.

In some embodiments, the user 12 may be a social media coordinator 14. In other embodiments the user 12 may be an administrative user 16 who manages system users 100.

In accordance with an exemplary embodiment of the present invention, a social media system 10 may be used by a user 12 in accordance with one or more of the following steps and combinations thereof. In some embodiments, the steps may be in order. In other embodiments, the steps may be followed in a different order. The user may create a user account, a user profile and a user database 90. The user may follow a log on process 20. The user may manage the user's registration 30. The user may create a post 40. The user may schedule a post 60 to one or more selected social media platforms. The system may process and complete the social media post and provide confirmation to the user 70. The system may send the post to the selected social media platforms 80. The system may store date in the user database 90. In some embodiments, the user 12 may be a social media coordinator 14. In some embodiments the user may be an administrative user 16, who manages users 100.

In an exemplary embodiment, The process includes management of the user registration 30. In order to use the application, the user must create an administrative account. Creation of a user account may include registration and authentication of the user on the application. The user may then log onto the system application. In some embodiments, a user database 90 is created when the user account is created. The user connects at least one user social media account to the at least one social media destination.

The log on process 20 includes the user log onto the system application by validating the user identification. If the log on credentials are invalid, an error message will be displayed.

In some embodiments the step of registration management further comprises creating a secured registration for a user profile, which may be capable of access to all social media platforms by the user. The secured user profile information is necessary to provide the user the ability to create posts and select their social media destination.

In some embodiments, the step of creating a user database may include registration and authentication of the user on the application, logging on by the user, establishing at least one user administrative account; and connection by the user of at least one user social media account to the at least one social media destination.

In an exemplary embodiment the present invention provides a computer-implemented method of simultaneously posting a social media post to a plurality of social media destinations. The method may comprise one or more of the following steps and combinations thereof: providing at least one computing device operable by a user, and providing a computer application downloadable to or accessible by at least one computing device.

In an exemplary embodiment the present invention provides a software program which comprises a machine-readable code for enabling the computing device and the user to perform a method comprising one or more of the following steps and combinations thereof.

a) creating a user database;
b) providing the user an option to create a social media post;
c) receiving a social media post created by the user;
d) providing the user an option to select at least one social media platform destination for the social media post selected from a group of social media platforms;
e) automatically generating a scheduling calendar page accessible by the user;
f) receiving from the user at least one schedule data set of date, time and social media platform destination for posting the social media post;
g) automatically posting the scheduled social media post to the at least one social media platform destination in accordance with the at least one schedule data set;
h) storing the social media post and the at least one schedule data set in the user database for analysis;
i) returning to step a) to provide the user an option to create and schedule at least one additional social media post;
j) analysis of data stored in the user database; and
k) generating a data analysis report accessible by the user.

The computer-implemented method for use by a user to simultaneously posting a social media post to a plurality of social media destinations may include the following process steps:

a) creating a user database;
b) providing the user an option to create a social media post;
c) receiving a social media post created by the user;
d) providing the user an option to select at least one social media platform destination for the social media post selected from a group of social media platforms;
e) automatically generating a scheduling calendar page accessible by the user;
f) receiving from the user at least one schedule data set of date, time and social media platform destination for posting the social media post;
g) automatically posting the scheduled social media post to the at least one social media platform destination in accordance with the at least one schedule data set;
h) storing the social media post and the at least one schedule data set in the user database for analysis;
i) returning to step a) to provide the user an option to create and schedule at least one additional social media post;
j) analysis of data stored in the user database; and
k) generating a data analysis report accessible by the user.

In an exemplary embodiment the present invention may provide a method of using a system for creating at least one social media post for posting on a plurality of social media platforms concurrently. The method may include one or more of the following steps and combinations thereof.

A user creates a post on the application.
The user selects the post destination (social media platform).
The user receives from the system the option to create new posts, and responds with “Yes” or “No”.
For the created post(s), the application will automatically generate a scheduling calendar page.
The user will then schedule posts based on day and time and social media platform destination.
The application will automatically post to social media networks based on day, time destination.
The user receives from the system the option to create new posts, and responds with “Yes” or “No”.
The system, application and Application will store data of date, time and destination of post to analyze.

As seen at FIG. 2, in an exemplary embodiment, the user may use and interact with the system in a process 200 comprising the following steps.

### (210): START.

(220): The user creates a new post and selects the social media network destination.
(230): Then the system generates a code for the post.
(240): The system requests if another post is to be created. If the user response is YES, repeat step (220), if NO, go to step (250).
(250): Generate a scheduling page.
(260): The user schedules the post(s).
(270): Then the system sends the posts to the selected social media platforms: the system posts the user's post(s) to the assigned network(s) at the scheduled time.
(280): The system asks to create another post for a second time. If YES, then go to step (220), if NO, go to step (290).
(290): The system stores the data in a database.

### (300): END PROCESS.

In an exemplary embodiment, the present invention may comprise a method including one or more of the following steps and combinations thereof.

1. First, a user may download the application software to a computing device. The user may navigate the application by the application user interface which comprises a plurality of navigation tabs at the top of the screen which include account information.
2. Second, in order to use the application , the user must register on the application with authentication and add administrative accounts, as necessary.
3. Third, the user may connect the user's social media accounts to the social media destinations on the application.
4. Fourth, a user database is created by the system and application for the user, to which the user's data and preferences are saved.
5. Fifth, in response to the user indicating intent to create at least one post, the system creates a plurality of fields for text messages, uploading images, and videos in different formats as well as documents.
6. Sixth, the user may then input data (text, images, video, etc.) in the fields to create the post(s).
7. Seventh the system creates a field for the social media destination of the post(s), selected from a plurality of social media platforms.
8. Eighth, the user may click the “apply” button to create multiple posts arranged by post destination.
9. Ninth, the system will then provide and display an interactive calendar for date and time selection for the posts.
10. Tenth, the system may provide the option to the user to drag and drop the post(s), or select all on the interactive calendar and schedule post(s) for the future.
11. Eleventh, the system calendar may highlight the posts by showing an indicator on the day of the post. The user may click on the day to see the exact time and destination and actual content of the post(s) already scheduled.
12. Twelfth, the system may provide a “Done” button by the user interface. In some embodiments the user may access a “Done” button at the bottom of the scheduling page. The user may click the “Done” button to return to the Dashboard page.
13. Thirteenth, the user may access the Dashboard page, which provides the option to click on the Analytics page, where the user may view analytics of past posts and scheduled posts and extract the data for reporting purposes.
14. Fourteenth, the Dashboard page may offer an option to display quick statistics, such as, for example without limitation, most popular time, most posts in a day, most popular social media network, or the like.
15. Fifteenth, the user may optionally compare posts data on a graph by selecting type of chart and time frame.

The elements, components and steps may interrelate in the following manner. The system may comprise a Dashboard comprising a plurality of Application Tabs. The plurality of tabs may comprise four application tabs which may be designated I. Posts; II. Dashboard; Ill. Account; and IV. User. These application tabs (I. Posts, II. Dashboard, III. Account, and IV. User) may include all of the steps 2-15 described hereinabove.

I. POST COMPONENT may include steps 5 through 12 described hereinabove.

II. DASHBOARD COMPONENT may include steps 4,13,14,15 described hereinabove.

III. ACCOUNT COMPONENT may include step 3 described hereinabove.

IV. USER COMPONENT may include step 2 described hereinabove.

In some embodiments the present invention comprises a simplified page or tab for creating posts and adding content such as, for example without limitation, text, photo, video, documents or the like.

Referring now to FIG. 3, in some embodiments, the present invention comprises a simplified scheduling page 350 that allows user to easily schedule posts based on date and time. In response to the user indicating intent to create at least one post, the system may provide access to the simplified scheduling page 350 which comprises a graphical user interface further comprising a plurality of fields. The scheduling page 350 comprises a plurality of fields: a text message field 352 for text messages; a date field 360a for selecting event date; a start time field 360b for selecting event start time; an end time field 360c for selecting end time; uploading field 354a for uploading images; uploading field 354b for uploading video or sound files; uploading field 354c for uploading documents; and a plurality of destination buttons 370 for selecting at least one social media destination. The social media destination may be any social media platform, for example without limitation, Instagram, Facebook, Twitter, Etsy, LinkedIn, YouTube, Facebook, Instagram, TikTok, Pinterest, Reddit, Snapchat, or combinations thereof. The scheduling page also includes an “Apply” button 372 for completing the scheduling process.

As seen at FIG. 4, the dashboard analytics page 400 includes access to user information including a plurality of statistics selected from most popular time, most posts in a day, most popular social media network. In some embodiments, an “Analytics” page is provided for download by pressing or clicking the download button 490 in order for user to learn about behavioral trends to understand marketing strategies. The downloadable data analysis report may include analytics of a plurality of posts including past posts and scheduled posts.

The method of the present invention enables users to create a single social media post for posting on multiple social media platforms, and schedule the same post multiple times throughout a certain period. The present invention allows users to use an application where they can create posts in one step instead of creating the same post multiple times for different platforms and schedule it based on when they want it to post automatically. The present invention may thereby enable users to use the present invention to produce automated posts to multiple destinations in a simple 3 step process. The present invention may also produce analyzed data on the social media posts for users to make marketing related decisions.

In some embodiments, the order provided for the steps must be done in that exact order for the process to be completed. In other embodiments, some of the process steps in the methods described herein may be completed in an alternative order.

To make this invention, one must build the software that is able to complete the requisite tasks and provide the user with the useful tool described above. The system method and software invention described herein may be created by building a web based application using fronted frameworks and cloud based databases. The Front-end part (the components and GUI) of the application may be created through Angular or similar frameworks used to create dynamic web based applications. The Backend portion may comprise an SQL database created and monitored in the cloud. The application programming interfaces (APIs) may be used to connect the frontend to the backend as well as connect the application to the social media networks. All software elements are necessary.

In summary, in an exemplary embodiment, the present invention provides a system and method for a user to create and schedule posts on multiple social media platforms simultaneously. The system and method enable a user to create and schedule posts for simultaneous posting on at least one social media destination. The social media destination may be any social media platform, for example without limitation, Instagram, Facebook, Twitter, Etsy, LinkedIn, YouTube, Facebook, Instagram, TikTok, Pinterest, Reddit, Snapchat, or combinations thereof.

The software system, application and method enable the user to create and schedule posts on multiple social media platforms, and permits the minimization of processing time of creating and scheduling of social media posts, thereby enabling the user to save time and money for future planning.

The present invention allows users to create posts on the application and schedule posting to multiple social media destinations simultaneously. The present invention permits the user to create posts in one location without limitations on the type of post. (text, photo, video, document). The user may select destinations from multiple social media platforms and schedule the post based on day, time, and social media platform destination. The present invention may be used to produce automated posts to multiple destinations in a simple 3-step process. The user therefore is able to avoid the enormous waste of time switching from one platform to another to create and post. It allows the processing time of creating and scheduling social media posts to be minimized, and saves time and money.

The present invention allows the user to retrieve statistics on all historical and planned posts, providing valuable marketing data, which may be beneficially used for future planning. It also produces analyzed data on the social media posts for users to make marketing related decisions. One optional element is downloading the data off of the application for further analytical purposes.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the present invention.

What is claimed is:

1. A system for a user to create and schedule posts on multiple social media platforms simultaneously, is comprised of:
a computing device operable by a user; and
a software program downloadable to the computing device or accessible by the computing device, the software program comprising:
a user dashboard accessible by the user on the computing device; and
a user database created by the software program for storage of the user data, user social media posts and user social media post data.

2. The system of claim 1 wherein the software program comprises a machine-readable code for enabling the computing device and the user to perform a method comprising the following steps:
a) creating a user database;
b) providing the user an option to create a social media post;
c) receiving a social media post created by the user;
d) providing the user an option to select at least one social media platform destination for the social media post selected from a group of social media platforms;
e) automatically generating a scheduling calendar page accessible by the user;
f) receiving from the user at least one schedule data set of date, time and social media platform destination for posting the social media post;
g) automatically posting the scheduled social media post to the at least one social media platform destination in accordance with the at least one schedule data set;
h) storing the social media post and the at least one schedule data set in the user database for analysis; and
i) returning to step a) to provide the user an option to create and schedule at least one additional social media post.

3. The system of claim 2 wherein the method further comprises:
j) analysis of data stored in the user database; and
k) generating a data analysis report accessible by the user.

4. The system of claim 3 wherein the data analysis report includes analytics of a plurality of posts including past posts and scheduled posts.

5. The system of claim 3 wherein the dashboard page includes access to user information including a plurality of statistics selected from most popular time, most posts in a day, most popular social media network.

6. The system of claim 3 wherein the at least one social media destination is selected from Instagram, Facebook, Twitter, Etsy, LinkedIn, YouTube, Facebook, Instagram, TikTok, Pinterest, Reddit, Snapchat, and combinations thereof.

7. The system of claim 6 wherein the step of creating a user database further comprises:
registration and authentication of the user on the application;
logging on by the user;
establishing at least one user administrative account; and
connection by the user of at least one user social media account to the at least one social media destination.

8. A computer-implemented method of simultaneously posting a social media post to a plurality of social media destinations, comprising:
providing at least one computing device operable by a user;
providing a computer application downloadable to or accessible by at least one computing device, the computer application comprising software for causing the at least one computer to perform the following process steps:
a) creating a user database;
b) providing the user an option to create a social media post;
c) receiving a social media post created by the user;
d) providing the user an option to select at least one social media platform destination for the social media post selected from a group of social media platforms;
e) automatically generating a scheduling calendar page accessible by the user;
f) receiving from the user at least one schedule data set of date, time and social media platform destination for posting the social media post;
g) automatically posting the scheduled social media post to the at least one social media platform destination in accordance with the at least one schedule data set;
h) storing the social media post and the at least one schedule data set in the user database for analysis; and
i) returning to step a) to provide the user an option to create and schedule at least one additional social media post.

9. The method of claim 8 further comprising the following steps:
j) analysis of data stored in the user database; and
k) generating a data analysis report accessible by the user.

10. The system of claim 9 wherein the at least one social media destination is selected from Instagram, Facebook, Twitter, Etsy, LinkedIn, YouTube, Facebook, Instagram, TikTok, Pinterest, Reddit, Snapchat, and combinations thereof.
